(19) United States
(12) Patent Application Publication
(10) Pub. No.: US 2025/0373614 A1
(43) Pub. Date: Dec. 4, 2025

(54) USER ACCESS CONTROL ON A NEED-BY-NEED BASIS

(71) Applicant: Roku, Inc., San Jose, CA (US)

(72) Inventors: Ritwick Babbar, Fremont, CA (US); Muhammad Israr Khan, Santa Clara, CA (US)

(21) Appl. No.: 18/675,543

(22) Filed: May 28, 2024

(51) Int. Cl. H04L 9/40

(52) U.S. Cl. CPC H04L 63/102

(57) ABSTRACT

Aspects of the disclosed technology provide solutions for dynamically controlling user access to computing resources on a need-by-need basis. An example method can include receiving an access request from a user. The access request may specify one or more computing resources to be accessed by the user. The example method further includes retrieving a user profile associated with the user, identifying a policy document specifying one or more user rights policies for the one or more computing resources, and determining, using a machine learning model, whether to grant or deny the access request based on the user profile and the policy document.

### BACKGROUND

### Field

This disclosure is generally directed to computing systems, and more particularly to dynamically controlling user access to computing resources on a need-by-need basis.

### SUMMARY

Provided herein are system, apparatus, article of manufacture, method and/or computer program product embodiments, and/or combinations and sub-combinations thereof, for dynamically controlling user access on a need basis in a computing environment.

In some aspects, a method is provided for dynamically determining user's accessibility to computing resources using a machine learning model. The method may be implemented by an electronic device, in one or more computing devices (e.g., servers, computers, mobile devices, IoT devices, etc.) that are communicatively coupled to the electronic device, and/or in a combination thereof. The method can operate by receiving an access request from a user. The access request may specify one or more computing resources to be accessed by the user. The method can include retrieving a user profile associated with the user and identifying a policy document specifying one or more user rights policies for the one or more computing resources. The method can further include determining, using a machine learning model, whether to grant or deny the access request based on the user profile and the policy document.

In some aspects, a system is provided for dynamically controlling user access on a need basis. The system can include one or more memories and at least one processor coupled to at least one of the one or more memories and configured to receive an access request from a user. The access request may specify one or more computing resources to be accessed by the user. The at least one processor of the system can also be configured to retrieve a user profile associated with the user and identify a policy document specifying one or more user rights policies for the one or more computing resources. The at least one processor of the system can also be configured to determine, using a machine learning model, whether to grant or deny the access request based on the user profile and the policy document.

In some aspects, a non-transitory computer-readable medium is provided for dynamically controlling user access on a need basis. The non-transitory computer-readable medium can have instructions stored thereon that, when executed by at least one computing device, cause the at least one computing device to receive an access request from a user. The access request may specify one or more computing resources to be accessed by the user. The instructions of the non-transitory computer-readable medium can, when executed by the at least one computing device, cause the at least one computing device to retrieve a user profile associated with the user and identify a policy document specifying one or more user rights policies for the one or more computing resources. Further, the instructions of the non-transitory computer-readable medium can, when executed by the at least one computing device, cause the at least one computing device to determine, using a machine learning model, whether to grant or deny the access request based on the user profile and the policy document.

### BRIEF DESCRIPTION OF THE FIGURES

The accompanying drawings are incorporated herein and form a part of the specification.

FIG. 1 illustrates a block diagram of an example environment for implementing a dynamic user access control system, according to some examples of the present disclosure.

FIG. 2 illustrates a diagram of an example system flow for controlling user access to computing resources, according to some examples of the present disclosure.

FIG. 3 illustrates an example model training for dynamic user access control, according to some examples of the present disclosure.

FIG. 4 illustrates a flowchart of an example method for controlling user access to computing resources on a need basis, according to some examples of the present disclosure.

FIG. 5 illustrates a flowchart of an example method for determining a scope and duration of user's accessibility, according to some examples of the present disclosure.

FIG. 6 illustrates a flowchart of an example method for determining accessible computing resources based on a user's task using a machine learning model, according to some examples of the present disclosure.

FIG. 7 illustrates a flowchart of an example method for determining accessible computing resources based on a user profile using a machine learning model, according to some examples of the present disclosure.

FIG. 8 is a diagram illustrating an example of a neural network architecture, according to some examples of the present disclosure.

FIG. 9 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Organizations and individuals rely on computing resources (e.g., applications, services, data sources, etc.) to perform various functions and tasks such as data processing, communication, document sharing, project management, storage of data, and so on. Computing resources often involve sensitive information such as confidential business information, personal data, proprietary information, etc. As follows, ensuring the security of these resources is essential to prevent unauthorized access and potential theft or tampering of sensitive data. For security measures, access control mechanisms can be implemented to limit access to confidential data to authorized users only. For example, users may be assigned an ID, password, and/or other authenticating information that may allow access to resources within their authority as determined by their access privileges. Also, users may be assigned permissions based on their roles and responsibilities within the organization for performing their job functions. However, such authentication-based or role-based user access control relies on predetermined privileges (e.g., roles, authorities, etc.) and is highly static, and therefore, can result in risks of excessive permissions.

Aspects of the disclosed technology provide solutions for dynamically controlling user access to computing resources on a need basis. In some aspects, a system can dynamically determine a user's accessibility for requested computing resources using machine learning techniques. The computing resources can include, for example and without limitation, applications, services, content, databases, or any applicable component in a computing environment. In some examples, a system can determine whether to grant or deny the access request, using a machine learning model, based on user information (e.g., user credentials, task, historical pattern of accessibility, expertise, etc.) and a policy document, which specifies user rights policies for the requested computing resources.

In some implementations, machine learning techniques can be used to analyze user information and/or a policy document to determine a degree and/or duration of the user's accessibility. For example, a large language model (LLM) can be used to learn context and meaning by recognizing relationships between words and/or phrases provided in a policy document, which describes access privileges with respect to accessing computing resources. As follows, the machine learning model can determine a scope of access (e.g., how much access is to be granted/denied for a user to access computing resources) based on the understanding of user information and the policy document. Also, the machine learning model can determine, if an access request is granted, a duration of the access (e.g., for how long access is to be granted).

As discussed in further detail below, the technologies and techniques described herein can improve the security and privacy of resources by ensuring that users only have access to the resources they are allowed on a need-by-need basis. Furthermore, user access can be dynamically controlled without manual management (e.g., human intervention for approval) and therefore, time and efforts for determining the scope of accessibility can be reduced while minimizing the risk of excessive permissions.

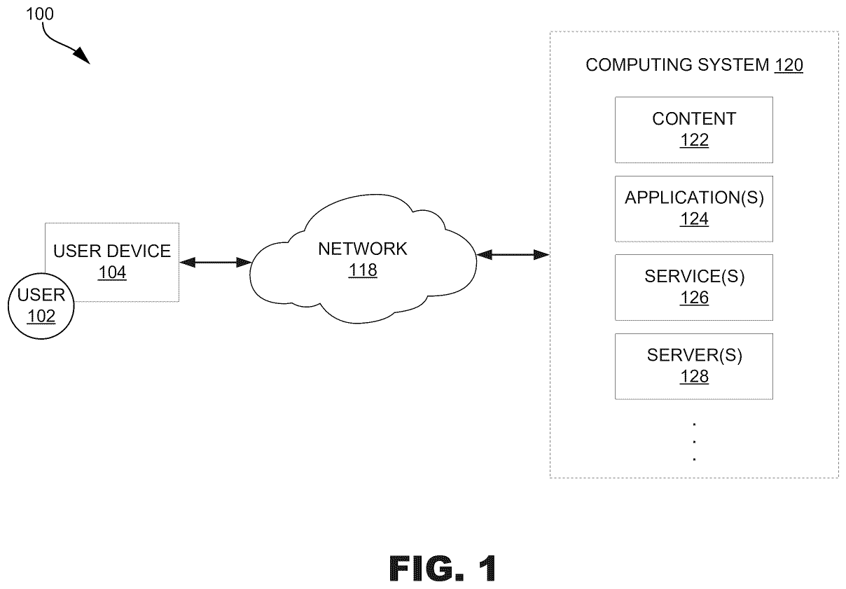

Various embodiments and aspects of this disclosure may be implemented using and/or may be part of an example environment 100 shown in FIG. 1. It is noted, however, that environment 100 is provided solely for illustrative purposes and is not limiting. Examples and embodiments of this disclosure may be implemented using, and/or may be part of, environments different from and/or in addition to the environment 100, as will be appreciated by persons skilled in the relevant art(s) based on the teachings contained herein. An example of the environment 100 shall now be described.

### Example Computing Environment

FIG. 1 illustrates a block diagram of an example environment 100 for implementing a dynamic user access control system, according to some examples of the present disclosure. In a non-limiting example, environment 100 may be directed to a computing environment that supports various computing operations and services such as data processing, media production and distribution, storage of data from various sources, data sharing and communications between different users, and so on. For example, environment 100 may include a multimedia environment directed to multimedia production and/or streamlining media content.

In this example, environment 100 includes a user 102 with user device 104 and a computing system 120. In multimedia environment 100, computing system 120 may be configured to process, produce, store, and/or distribute (e.g., stream) multimedia content (e.g., content 122). For example, computing system 120 may receive an access request from user 102 whose responsibilities or tasks are related to the production, storage, and/or distribution of media content.

The user device 104 (e.g., computers, mobile devices, IoT devices, etc.) may communicate with computing system 120 via network 118. In various examples, network 118 (e.g., a communication network) can include, without limitation, a wired and/or wireless network, a public network (e.g., a wide area network, etc.), a software-defined network (SDN), an extranet, Internet, cellular, Bluetooth, infrared, and/or any other short range, long range, local, regional, global communications mechanisms, means, approach, protocol and/or network, as well as any combination(s) thereof.

As illustrated, computing system 120 may include various computing resources such as content 122, application(s) 124, service(s) 126, server(s) 128, database(s), storage(s), and so on. The various computing resources are available and accessible to user 102. For example, user 102 may use user device 104 to transmit an access request, via network 118, specifying resources of computing system 120 to be accessed by user 102.

The computing system 120 may include content 122, which may be stored in server(s) 128. Content 122 may include any combination of music, videos, movies, TV programs, multimedia, images, still pictures, text, graphics, gaming applications, advertisements, programming content, public service content, government content, local community content, targeted media content, software, and/or any other content or data objects in electronic form.

In some examples, content 122 further includes metadata associated with content 122. For example, metadata may include associated or ancillary information indicating or related to writer, director, producer, composer, artist, actor, summary, chapters, production, history, year, trailers, alternate versions, related content, applications, and/or any other information pertaining or relating to the content 122.

The computing system 120 may include software resources such as application(s) 124 (e.g., programs) to perform specific tasks or operating systems for running applications. For example, computing system 120 can include application(s) 124 that support content creation, editing, management, and streaming. In various examples, application(s) 124 can include, without limitation, video editing applications, audio editing applications, graphic design applications, content management applications, media streaming applications, and/or any applicable applications.

In some aspects, computing system 120 may include various service(s) 126 that provide functionality or access to resources over a network (e.g., network 118). For example, service(s) 126 can include, without limitation, data ingestion services, video transcoding services, aggregation services, streaming services, provider billing services, contract management services, cloud services, troubleshooting services, deployment services, monitoring services, artificial intelligence (AI) and machine learning (ML) services, and/or any applicable services.

In some examples, computing system 120 may include one or more server(s) 128. In some aspects, server(s) 128 can provide, to user device 104, content 122, application(s) 124, service(s) 126, etc. The server(s) 128 can include, for example and without limitation, a physical server computer, a virtualized server (e.g., software containers, virtual machines, etc.), cloud and/or application appliances, a distributed computing system, and/or any other server system.

In some aspects, computing system 120 may maintain policies (e.g., rules, guidelines, procedures, etc.) that dictate how computing system 120 should be used, managed, and accessed with respect to its resources (e.g., content 122, application(s) 124, service(s) 126, server(s) 128, etc.). In some illustrations, policies may include security policies that specify who is authorized to access specific resources within computing system 120, how resources should be handled and/or protected from users' access within computing system 120, acceptable and prohibited uses of resources within computing system 120, and so on. For example, an administrator of computing system 120 may specify an access control policy that dictates the access privileges given to user(s) (e.g., user 102) that relate to various computing resources.

### User Access Control on a Need Basis

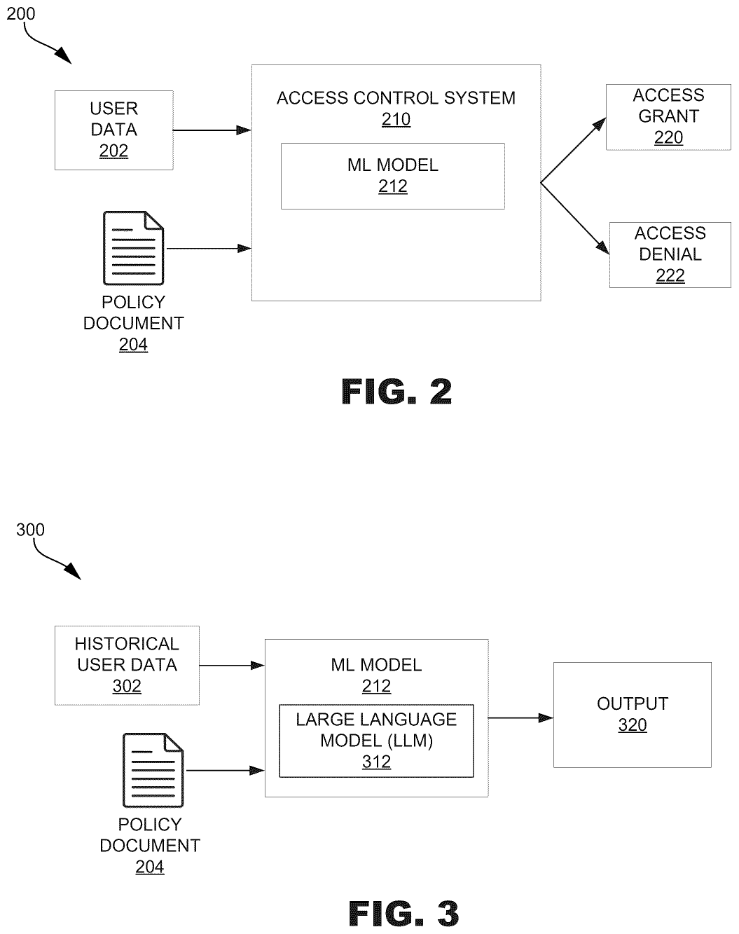

FIG. 2 illustrates a diagram of an example system flow 200 for controlling user access to computing resources on a need basis, according to some examples of the present disclosure. In some examples, access control system 210 can be part of or implemented by server(s) 128 illustrated in FIG. 1. For example, access control system 210 can be a software algorithm running on the server(s) 128. In other examples, access control system 210 can be separate from the server(s) 128. For example, access control system 210 can be or can be implemented by a different server(s), a datacenter, a software container hosted on a different system (e.g., a server(s), a cloud system, an on-premises system, etc.).

The access control system 210 can be configured to determine a user's accessibility to computing resources within computing system 120 (e.g., content 122, application(s) 124, service(s) 126, server(s) 128, etc.) such that access control system 210 can, based on user data 202 and policy document 204, assign user permissions such as by generating access grant 220 or access denial 222. For example, when user 102 requests access to certain computing resources, access control system 210 can evaluate user data 202 and policy document 204 to determine whether to grant or deny the access request to the computing resources.

In some aspects, access control system 210 can retrieve user data 202 (e.g., user profile, user profile data, etc.) associated with a user (e.g., user 102). For example, user data 202 can include a user access request, which specifies computing resource(s) to be accessed by the user. Further, user data 202 can include, for example and without limitation, user credentials, a history of access patterns of the user, a history of the user's accessibility within the computing system (e.g., incidences where the user was granted access or denied access), a history of the user's access to the requested computing resources, task(s) assigned to the user, a role of the user, job responsibilities of the user, expertise of the user, and so on.

In some examples, access control system 210 may identify a policy document 204 relating to computing resources within the computing system (e.g., computing resources that are requested for access in the user's access request). For example, policy document 204 may specify, in text, one or more user rights policies for the computing resources, including, for example without limitation, a level of sensitivity or confidentiality, applicability (e.g., systems, resources, users, and actions that are covered by the policy) or limitations, etc. In some aspects, the policy document may describe general access control principles or rules intended for a specific set of users, task type and/or for a particular set of computing or data resources.

In some illustrations, policy document 204 may include a description of various components of a system. For example, policy document 204 for a content management system may include details about services of video encoder, packager, or Content Delivery Network (CDN), how these services are expected to operate, and the operations that these services can perform. In some examples, policy document 204 can include descriptions relating to what a flow state machine would look like. Further, in some aspects, policy document 204 can describe errors that may occur at each stage, measurements that can be taken in event of an error or anomaly, permissions that would be needed to address the error or anomaly, a duration or period of time that the permission needs to be granted, and a list of users who can address the error or anomaly, which can be retrieved from the user history of access patterns.

In some aspects, access control system 210 can include an ML model 212 for dynamically determining whether to grant or deny the access request (i.e., access grant 220 or access denial 222) based on user data 202 and policy document 204. That is, access control system 210 can include an applicable machine learning-based model or neural network for determining the user's accessibility to computing resources within computing system 120 based on one or more attributes associated with user 102 or the requested computing resources, which are derived from user data 202 and policy document 204.

For example, ML model 212 can be configured to process and evaluate user data 202 and policy document 204 to recognize accessibility patterns associated with user 102 or computing resources. In some examples, ML model 212 is configured to learn and/or understand context or identify attributes associated with user 102 based on user data 202. For example, instead of determining the user's accessibility solely based on a role or position of user 102, ML model 212 can collectively evaluate various attributes of user 102 (e.g., user credentials, a history of access patterns of the user, a history of the user's accessibility within the computing system, a history of the user's access to the requested computing resources, task(s) assigned to the user, a role of the user, job responsibilities of the user, expertise of the user, etc.).

In some aspects, ML model 212 can perform policy document analysis on a level of sensitivity or confidentiality with respect to computing resources (e.g., content 122, application(s) 124, service(s) 126, server(s) 128, etc.), applicability (e.g., systems, resources, users, and actions that are covered by the policy) or limitations, and so on.

In some illustrations, ML model 212 can be (or can include) a large language model (LLM), which is configured to learn patterns and relationships within the language provided in policy document 204. As illustrated previously, policy document 204 can include words and phrases that define various rules and guidelines with respect to access privileges and/or restrictions within computing system 120. As follows, the LLM can learn to interpret policy document 204 and/or extract information about policy document 204 to generate a richer description of user privileges for computing resources within computing system 120. For example, the LLM can, by tracking the relationships and patterns in policy document 204, understand the structure of user rights policies for different resources and for different individuals/users.

In some illustrations, access control system 210 or ML model 212 can further determine the scope of the granted access based on the information and/or attributes associated with user 102 and computing resources derived from user data 202 and policy document 204. For example, for access grant 220, access control system 210 or ML model 212 can determine the scope/degree/level of the user's accessibility such as computing resources accessible by the user, actions/activities that are allowed, features that are available to the user, etc. In some cases, access control system 210 can limit or expand the scope of access compared to what is requested in an access request from user 102. For example, based on the understanding of user data 202 and policy document 204, access control system 210 or ML model 212 can adjust the scope of the user's accessibility.

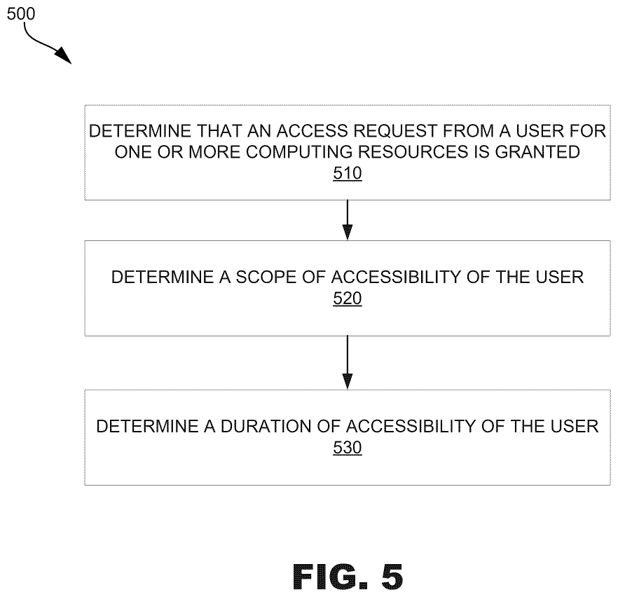

Further, access control system 210 or ML model 212 can determine the duration of the granted access based on the information and/or attributes associated with user 102 and computing resources derived from user data 202 and policy document 204. For example, for access grant 220, access control system 210 or ML model 212 can determine the period of time (length of time) for the granted access (or how long the granted access remains) based on a security level of the computing resources, a role of the user, and a scope of a task that requires access to the computing resources, etc. Further details regarding the scope and duration of the access are described below with respect to FIG. 5.

In some examples, access control system 210 may, using ML model 212, examine access rights for multiple users based on policy document 204. That is, ML model 212 (e.g., LLM) can evaluate and analyze policy document 204 to understand the context and meanings of user privileges for various computing resources. The ML model 212 can, based on the comprehensive understanding of the user privileges for various computing resources within the computing system 120, examine access rights for users.

In some illustrations, access control system 210 may, using ML model 212, determine a validity of policy document 204. For example, ML model 212 or an LLM can learn to extract meanings and understand the relationships between words such that ML model 212 can determine whether at least a portion of policy document 204 is valid. If access control system 210 determines that at least a portion of policy document 204 is invalid, access control system 210 can generate an alert such that the portion of policy document 204 can be revised.

FIG. 3 illustrates a diagram of model training 300 for dynamic user access control, according to some examples of the present disclosure. As described previously, ML model 212 can include an artificial neural network such as an LLM (e.g., LLM 312) configured to process text from an input, such as policy document 204. In some examples, LLM 312 can be configured to learn and/or understand semantics in text, ontology information associated with text, syntax information, classification information, tokens associated with text, context, and/or any other task or feature of an LLM. As follows, LLM 312 can understand, from policy document 204, the compressive landscape of user access policies regarding various computing resources within computing system 120.

The ML model 212 can be trained on historical user data 302, which represents cases in the past where an access request was granted or denied, computing resources that a user had access in the past, a type of computing resources that allowed limited access (e.g., a final episode of television series, a trailer of an upcoming movie, etc.), and so on.

In some aspects, the LLM 312 can be trained on text data from various sources including policy document 204. During training, LLM 312 can learn to recognize patterns and relationships between words and phrases provided in policy document 204. For example, LLM 312 can learn to process policy document 204 to better understand user privileges, relationships and/or patterns associated with user's accessibility or privileges within computing system, features of policy document 204, and/or other information about the user privileges. The LLM 312 can apply this understanding to produce output 320, which may include a user accessibility determination (e.g., access grant 220 or access denial 222). Once trained, LLM 312 can generate output 320 (e.g., access determination whether to grant or deny) without explicit training or re-training with policy document 204.

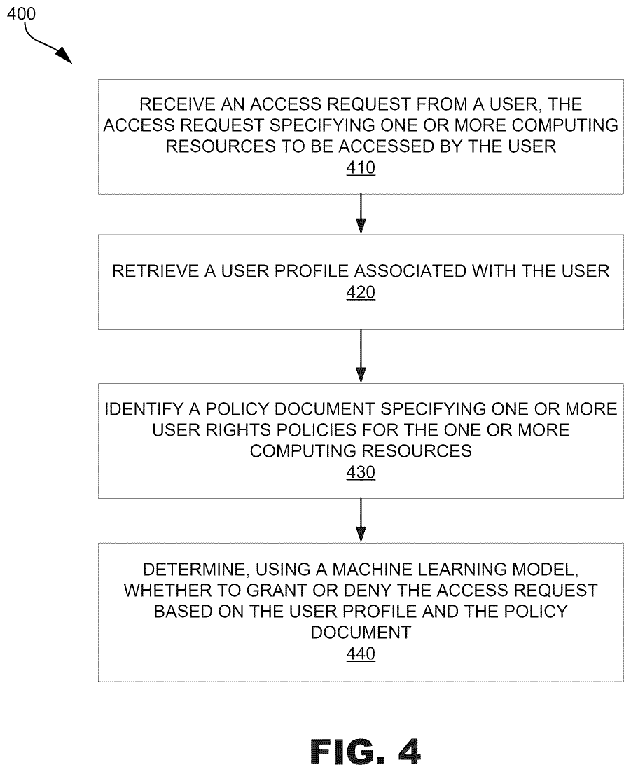

FIG. 4 illustrates a flowchart of an example method 400 for controlling user access to computing resources on a need basis, according to some examples of the present disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIGS. 1-3. However, method 400 is not limited to that example.

At step 410, method 400 includes receiving an access request from a user. The access request may specify one or more computing resources to be accessed by the user. For example, access control system 210 may receive an access request from user 102, via network 118. The access request may specify one or more computing resources (e.g., content 122, application(s) 124, service(s) 126, server(s) 128, etc.) of computing system 120 that are requested by user 102 to access. For example, user 102 may request to access a video editing application 124 to edit media content 122, which is stored in a server 128 of computing system 120.

At step 420, method 400 includes retrieving a user profile associated with the user. For example, access control system 210 may retrieve user profile (e.g., user data 202) associated with user 102, which may include user profile information such as user credentials, a history of access patterns of the user, a history of the user's access to the one or more computing resources, a task given to the user, a role of the user, an expertise of the user, and/or any applicable user information relating to various computing resources of computing system 120.

In some examples, access control system 210 may evaluate user data 202 to determine whether user 102 had access, in the past, to the particular resource requested in the user request. If so, access control system 210 may further determine the scope and/or duration of the access in the past. For example, access control system 210 may look at user data 202 to see if user 102 was able to access the video editing application 124, and if so, determine the type of features/actions that were allowed in the video editing application 124. Also, access control system 210 may determine if user 102 was able to access media content 122 and if so, a type of actions or activities that were allowed (e.g., read-only, play-only, read-write, edit, execute, etc.).

At step 430, method 400 includes identifying a policy document specifying one or more user rights policies for the one or more computing resources. For example, access control system 210 may identify policy document 204, which specifies user privileges or user rights policies for the computing resources that are requested in the access request. In some examples, policy document 204 may be generated manually and kept up-to-date with the evolving system design. In various examples, policy document 204 may define, in text, a level of sensitivity or confidentiality, applicability (e.g., systems, resources, users, and features/actions that are covered by the policy) or limitations, or any information relating to user privileges for the computing resources of computing system 120.

At step 440, method 400 includes determining, using a machine learning model, whether to grant or deny the access request based on the user profile and the policy document. For example, access control system 210 may determine, using a machine learning model (e.g., ML model 212 or LLM 312), whether to grant or deny the access request based on user data 202 and policy document 204. The ML model 212 or LLM 312 can understand the overall structure of computing system 120 including various computing resources (e.g., content 122, application(s) 124, service(s) 126, server(s) 128, etc.) and therefore, determine whether user 102 has an authority/permission or is allowed to access particular computing resources.

In some examples, method 400 includes revising the policy document to generate an updated policy document. For example, based on the understanding of user data 202 and policy document 204 using ML model 212, access control system 210 may revise policy document 204 to generate an updated policy document. As follows, access control system 210 may determine, by the machine learning model (e.g., ML model 212), whether to grant or deny the access request based on the updated policy document.

FIG. 5 illustrates a flowchart of an example method for determining a scope and duration of user's accessibility, according to some examples of the present disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 500 shall be described with reference to FIGS. 1-3. However, method 500 is not limited to that example.

At step 510, method 500 includes determining that an access request from a user for one or more computing resources is granted. For example, based on user data 202 and policy document 204, access control system 210 may determine access grant 220, which allows user 102 to access the computing resources.

At step 520, method 500 includes determining a scope of accessibility of the user. For example, access control system 210 may determine a scope (e.g., degree or level) of access to computing resources that are available to user 102. For example, access control system 210 may, based on the analysis of user data 202 and policy document 204 using ML model 212, determine certain computing resources that user 102 is authorized to access, actions/activities that are available to user 102, features that are available to user 102, etc.

For example, if user 102 has requested to access content 122, access control system 210 may determine, based on the analysis of user data 202 and policy document 204, that a portion of content 122 contains highly confidential information, which cannot be released to user 102 and therefore, grant access to the rest portion of content 122. In another example, if user 102 has requested to access a media editing application, access control system 210 may determine, based on the analysis of user data 202 and policy document 204, that user 102 can edit audio only and is not allowed to edit video.

In some examples, access control system 210 may adjust the scope of access, which may be different than what is requested in the access request from user 102. That is, access control system 210 may limit or extend what is accessible by user 102 within computing system 120 based on the analysis of user data 202 and/or policy document 204.

At step 530, method 500 includes determining a duration of accessibility of the user. For example, access control system 210 may determine a duration of access (e.g., a length in time that user can access the computing resources). For example, access control system 210 or ML model 212 can look at historical access patterns of user 102 (e.g., how much time user 102 had spent with granted access), a scope or level of a task that requires access to the computing resources (e.g., how much time is needed to complete a task that is assigned to user 102), a security level of the computing resources, etc.

In some aspects, access control system 210 can identify a task that is assigned to user 102 and requires access to the computing resources. In this example, access control system 210 can determine when the task is completed. In response to determining that the task has been completed, access control system 210 may revoke the access request for user 102 to the computing resources such that user 102 may not access the computing resources once the task is completed.

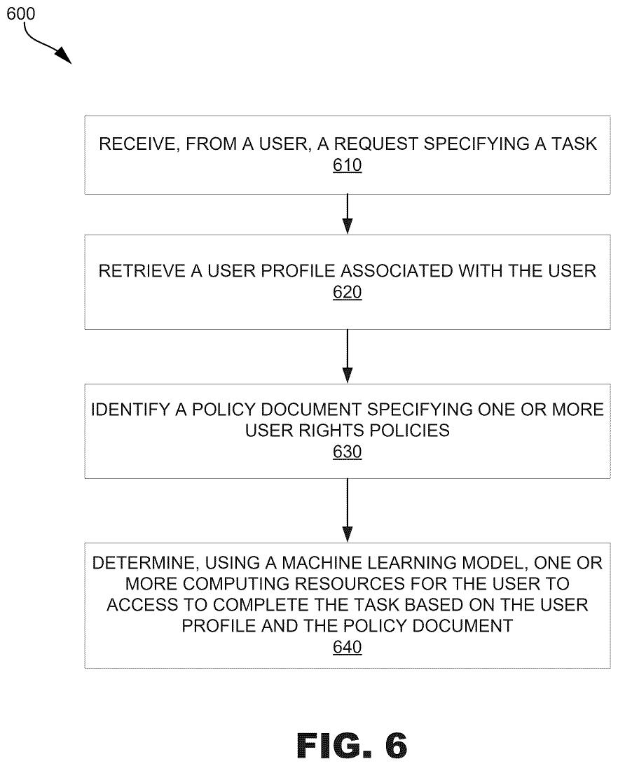

FIG. 6 illustrates a flowchart of an example method for determining accessible computing resources based on a user's task using a machine learning model, according to some examples of the present disclosure. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art. Method 600 shall be described with reference to FIGS. 1-3. However, method 600 is not limited to that example.

At step 610, method 600 includes receiving, from a user, a request specifying a task. For example, access control system 210 may receive from user 102, a request specifying a task that is assigned to user 102 or a problem that user 102 would like to solve. In this example, the request may not specify computing resources that are needed to complete the task or solve the problem that user 102 is facing.

At step 620, method 600 includes retrieving a user profile associated with the user. For example, access control system 210 may retrieve user data 202 associated with user 102. As illustrated previously, user data 202 (e.g., user profile information) may include user credentials, a history of access patterns of the user, a history of the user's accessibility within the computing system (e.g., incidences where the user was granted access or denied access), a history of the user's access to the requested computing resources, a role of the user, job responsibilities of the user, expertise of the user, and/or any information associated with user 102.

At step 630, method 600 includes identifying a policy document specifying one or more user rights policies. For example, access control system 210 may identify policy document 204, which specifies user rights policies for various computing resources (e.g., content 122, application(s) 124, service(s) 126, server(s) 128, etc.) within computing system 120. As described previously, policy document 204 may define a level of sensitivity or confidentiality, applicability (e.g., systems, resources, users, and features/actions that are covered by the policy) or limitations, or any information relating to user privileges for the computing resources.

At step 640, method 600 includes determining, using a machine learning model, one or more computing resources for the user to access to complete the task based on the user profile and the policy document. That is, access control system 210 may identify, using ML model 212, appropriate access for user 102 to complete the task or solve the problem. For example, access control system 210 may determine, using ML model 212, computing resources that user 102 needs to access and for how long the access needs to be allowed, in order to successfully and timely complete the task.

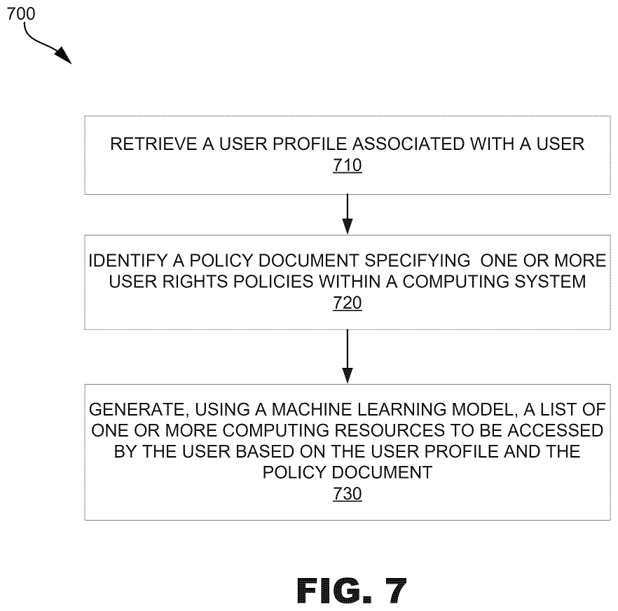

FIG. 7 illustrates a flowchart of an example method 700 for determining accessible computing resources based on a user profile using a machine learning model, according to some examples of the present disclosure. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art. Method 700 shall be described with reference to FIGS. 1-3. However, method 700 is not limited to that example.

At step 710, method 700 includes retrieving a user profile associated with a user. For example, access control system 210 may retrieve user data 202 associated with user 102. The user data 202 can include user credentials, a history of access patterns of the user, a history of the user's accessibility within the computing system (e.g., incidences where the user was granted access or denied access), a history of the user's access to the requested computing resources, a role of the user, job responsibilities of the user, a task assigned to user 102, expertise of the user, and/or any information associated with user 102.

At step 720, method 700 includes identifying a policy document specifying rules and guidelines structuring who can access computing resources. For example, access control system 210 may identify policy document 204, which specifies user privileges or user rights policies for various computing resources (e.g., content 122, application(s) 124, service(s) 126, server(s) 128, etc.) of computing system 120.

At step 730, method 700 includes generating, using a machine learning model, a list of one or more computing resources to be accessed by the user based on the user profile and the policy document. For example, access control system 210 may generate, using ML model 212, a list of computing resources (e.g., content 122, application(s) 124, service(s) 126, server(s) 128, etc.) within computing system 120 that user 102 is permitted to access based on the information derived from user data 202 and/or policy document 204. As follows, access control system 210 may define, for each user, a scope of the user's privileges for various computing resources of computing system 120.

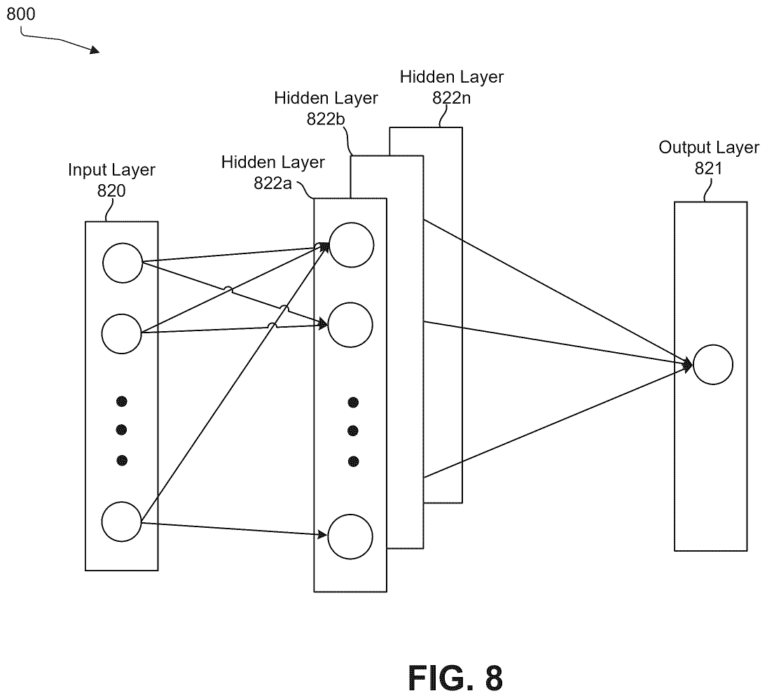

FIG. 8 is a diagram illustrating an example of a neural network architecture 800 that can be used to implement some or all of the neural networks described herein (e.g., ML model 212 or LLM 312). The neural network architecture 800 can include an input layer 820 can be configured to receive and process data to generate one or more outputs. The neural network architecture 800 also includes hidden layers 822a, 822b, through 822n. The hidden layers 822a, 822b, through 822n include “n” number of hidden layers, where “n” is an integer greater than or equal to one. The number of hidden layers can be made to include as many layers as needed for the given application. The neural network architecture 800 further includes an output layer 821 that provides an output resulting from the processing performed by the hidden layers 822a, 822b, through 822n.

The neural network architecture 800 is a multi-layer neural network of interconnected nodes. Each node can represent a piece of information. Information associated with the nodes is shared among the different layers and each layer retains information as information is processed. In some cases, the neural network architecture 800 can include a feed-forward network, in which case there are no feedback connections where outputs of the network are fed back into itself. In some cases, the neural network architecture 800 can include a recurrent neural network, which can have loops that allow information to be carried across nodes while reading in input.

Information can be exchanged between nodes through node-to-node interconnections between the various layers. Nodes of the input layer 820 can activate a set of nodes in the first hidden layer 822a. For example, as shown, each of the input nodes of the input layer 820 is connected to each of the nodes of the first hidden layer 822a. The nodes of the first hidden layer 822a can transform the information of each input node by applying activation functions to the input node information. The information derived from the transformation can then be passed to and can activate the nodes of the next hidden layer 822b, which can perform their own designated functions. Example functions include convolutional, up-sampling, data transformation, and/or any other suitable functions. The output of the hidden layer 822b can then activate nodes of the next hidden layer, and so on. The output of the last hidden layer 822n can activate one or more nodes of the output layer 821, at which an output is provided. In some cases, while nodes in the neural network architecture 800 are shown as having multiple output lines, a node can have a single output and all lines shown as being output from a node represent the same output value.

In some cases, each node or interconnection between nodes can have a weight that is a set of parameters derived from the training of the neural network architecture 800. Once the neural network architecture 800 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 800 to be adaptive to inputs and able to learn as more and more data is processed.

The neural network architecture 800 is pre-trained to process the features from the data in the input layer 820 using the different hidden layers 822a, 822b, through 822n in order to provide the output through the output layer 821.

In some cases, the neural network architecture 800 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 800 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 800 can perform a backward pass by determining which inputs (weights) most contributed to the loss of the network, and can adjust the weights so that the loss decreases and is eventually minimized.

The neural network architecture 800 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 800 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

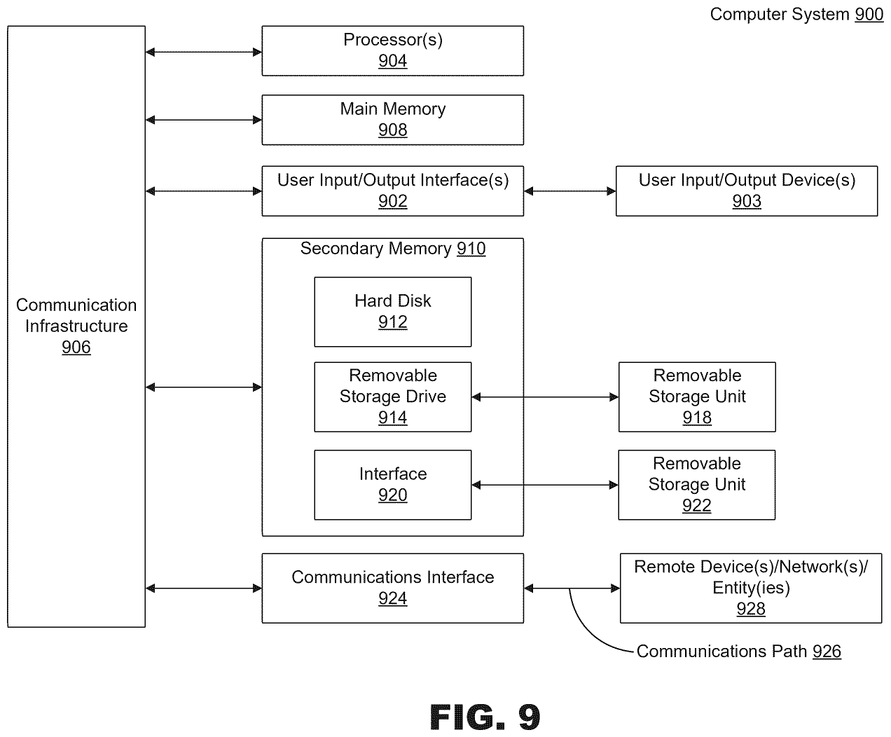

Various aspects and examples may be implemented, for example, using one or more well-known computer systems, such as computer system 900 shown in FIG. 9. For example, user device 104 or any device with computing system 120 may be implemented using combinations or sub-combinations of computer system 900. Also or alternatively, one or more computer systems 900 may be used, for example, to implement any of the aspects and examples discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 900 may include a communication or network interface 924. Communication interface 924 may enable computer system 900 to communicate and interact with any combination of external devices, external networks, external entities, etc. (individually and collectively referenced by reference number 928). For example, communication interface 924 may allow computer system xx00 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900 or processor(s) 904), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: one or more memories; and at least one processor coupled to at least one of the one or more memories and configured to perform operations comprising: receiving an access request from a user, the access request specifying one or more computing resources to be accessed by the user; retrieving a user profile associated with the user; identifying a policy document specifying one or more user rights policies for the one or more computing resources; and determining, using a machine learning model, whether to grant or deny the access request based on the user profile and the policy document.

Aspect 2. The system of Aspect 1, wherein the at least one processor is configured to perform operations comprising: revising the policy document to generate an updated policy document; and determining, by the machine learning model, whether to grant or deny the access request based on the updated policy document.

Aspect 3. The system of any of Aspects 1 to 2, wherein the at least one processor is configured to perform operations comprising: determining a degree of accessibility of the user in response to a determination that the access request is granted.

Aspect 4. The system of any of Aspects 1 to 3, wherein the at least one processor is configured to perform operations comprising: determining a duration of accessibility of the user in response to a determination that the access request is granted.

Aspect 5. The system of Aspect 4, wherein the duration of the accessibility is configured based on at least one of a security level of the one or more computing resources, a role of the user, and a scope of a task that requires access to the one or more computing resources.

Aspect 6. The system of any of Aspects 1 to 5, wherein the access request for the one or more computing resources is for completing a task, and the at least one processor is configured to perform operations comprising: determining that the task is completed; and revoking the access request of the user to the one or more computing resources in response to the determination that the task is completed.

Aspect 7. The system of any of Aspects 1 to 6, wherein the user profile includes at least one of user credentials, a history of access patterns of the user, a history of the user's access to the one or more computing resources, a task given to the user, a role of the user, and an expertise of the user.

Aspect 8. The system of any of Aspects 1 to 7, wherein the at least one processor is configured to perform operations comprising: examining, using the machine learning model, access rights for a plurality of users based on the policy document.

Aspect 9. The system of any of Aspects 1 to 8, wherein the at least one processor is configured to perform operations comprising: determining a validity of the policy document with respect to the one or more computing resources; and generating an alert in response to determining that the policy document is invalid.

Aspect 10. The system of any of Aspects 1 to 9, wherein the machine learning model includes a large language model (LLM).

Aspect 11. A method comprising: receiving an access request from a user, the access request specifying one or more computing resources to be accessed by the user; retrieving a user profile associated with the user; identifying a policy document specifying one or more user rights policies for the one or more computing resources; and determining, using a machine learning model, whether to grant or deny the access request based on the user profile and the policy document.

Aspect 12. The method of Aspect 11, further comprising: revising the policy document to generate an updated policy document; and determining, by the machine learning model, whether to grant or deny the access request based on the updated policy document.

Aspect 13. The method of any of Aspects 11 to 12, further comprising: determining a degree of accessibility of the user in response to a determination that the access request is granted.

Aspect 14. The method of any of Aspects 11 to 13, further comprising: determining a duration of accessibility of the user in response to a determination that the access request is granted.

Aspect 15. The method of Aspect 14, wherein the duration of the accessibility is configured based on at least one of a security level of the one or more computing resources, a role of the user, and a scope of a task that requires access to the one or more computing resources.

Aspect 16. The method of any of Aspects 11 to 15, wherein the access request for the one or more computing resources is for completing a task, and the method further comprises: determining that the task is completed; and revoking the access request of the user to the one or more computing resources in response to the determination that the task is completed.

Aspect 17. The method of any of Aspects 11 to 16, wherein the user profile includes at least one of user credentials, a history of access patterns of the user, a history of the user's access to the one or more computing resources, a task given to the user, a role of the user, and an expertise of the user.

Aspect 18. The method of any of Aspects 11 to 17, further comprising: examining, using the machine learning model, access rights for a plurality of users based on the policy document.

Aspect 19. The method of any of Aspects 11 to 18, wherein the machine learning model includes a large language model (LLM).

Aspect 20. A non-transitory computer-readable medium having instructions stored thereon that, when executed by at least one computing device, cause the at least one computing device to perform a method according to any of Aspects 11 to 19.

Aspect 21. A system comprising means for performing a method according to any of Aspects 11 to 19.

Aspect 22. A computer program product having stored thereon instructions which, when executed by one or more processors, cause the one or more processors to perform a method according to any of Aspects 11 to 19.

What is claimed is:

1. A system comprising:
one or more memories; and
at least one processor coupled to at least one of the one or more memories and configured to perform operations comprising:
receiving an access request from a user, the access request specifying one or more computing resources to be accessed by the user;
retrieving a user profile associated with the user;
identifying a policy document specifying one or more user rights policies for the one or more computing resources; and
determining, using a machine learning model, whether to grant or deny the access request based on the user profile and the policy document.

2. The system of claim 1, wherein the at least one processor is configured to perform operations comprising:
revising the policy document to generate an updated policy document; and
determining, by the machine learning model, whether to grant or deny the access request based on the updated policy document.

3. The system of claim 1, wherein the at least one processor is configured to perform operations comprising:
determining a degree of accessibility of the user in response to a determination that the access request is granted.

4. The system of claim 1, wherein the at least one processor is configured to perform operations comprising:
determining a duration of accessibility of the user in response to a determination that the access request is granted.

5. The system of claim 4, wherein the duration of the accessibility is configured based on at least one of a security level of the one or more computing resources, a role of the user, and a scope of a task that requires access to the one or more computing resources.

6. The system of claim 1, wherein the access request for the one or more computing resources is for completing a task, and the at least one processor is configured to perform operations comprising:
determining that the task is completed; and
revoking the access request of the user to the one or more computing resources in response to the determination that the task is completed.

7. The system of claim 1, wherein the user profile includes at least one of user credentials, a history of access patterns of the user, a history of the user's access to the one or more computing resources, a task given to the user, a role of the user, and an expertise of the user.

8. The system of claim 1, wherein the at least one processor is configured to perform operations comprising:
examining, using the machine learning model, access rights for a plurality of users based on the policy document.

9. The system of claim 1, wherein the at least one processor is configured to perform operations comprising:
determining a validity of the policy document with respect to the one or more computing resources; and
generating an alert in response to determining that the policy document is invalid.

10. The system of claim 1, wherein the machine learning model includes a large language model (LLM).

11. A method comprising:
receiving an access request from a user, the access request specifying one or more computing resources to be accessed by the user;
retrieving a user profile associated with the user;
identifying a policy document specifying one or more user rights policies for the one or more computing resources; and
determining, using a machine learning model, whether to grant or deny the access request based on the user profile and the policy document.

12. The method of claim 11, further comprising:
revising the policy document to generate an updated policy document; and
determining, by the machine learning model, whether to grant or deny the access request based on the updated policy document.

13. The method of claim 11, further comprising:
determining a degree of accessibility of the user in response to a determination that the access request is granted.

14. The method of claim 11, further comprising:
determining a duration of accessibility of the user in response to a determination that the access request is granted.

15. The method of claim 14, wherein the duration of the accessibility is configured based on at least one of a security level of the one or more computing resources, a role of the user, and a scope of a task that requires access to the one or more computing resources.

16. The method of claim 11, wherein the access request for the one or more computing resources is for completing a task, and the method further comprises:
determining that the task is completed; and
revoking the access request of the user to the one or more computing resources in response to the determination that the task is completed.

17. The method of claim 11, wherein the user profile includes at least one of user credentials, a history of access patterns of the user, a history of the user's access to the one or more computing resources, a task given to the user, a role of the user, and an expertise of the user.

18. The method of claim 11, further comprising:
examining, using the machine learning model, access rights for a plurality of users based on the policy document.

19. The method of claim 11, wherein the machine learning model includes a large language model (LLM).

20. A non-transitory computer-readable medium having instructions stored thereon that, when executed by at least one computing device, cause the at least one computing device to perform operations comprising:
receiving an access request from a user, the access request specifying one or more computing resources to be accessed by the user;
retrieving a user profile associated with the user;
identifying a policy document specifying one or more user rights policies for the one or more computing resources; and
determining, using a machine learning model, whether to grant or deny the access request based on the user profile and the policy document.
